(19) United States
(12) Patent Application Publication
(10) Pub. No.: US 2026/0211416 A1
(43) Pub. Date: Jul. 23, 2026

(54) ROBOTIC LAWNMOWER SYSTEM WITH AN AUGMENTED REALITY USER INTERFACE

(71) Applicant: HUSQVARNA AB, Huskvarna (SE)

(72) Inventors: Simon ARVIDSSON, Huskvarna (SE); Christian BONDESSON, Huskvarna (SE); Tommy SVENSSON, Huskvarna (SE); Johan BERGMAN, Huskvarna (SE); Bjorn MANNEFRED, Huskvarna (SE); Beppe HELLSIN, Huskvarna (SE)

(21) Appl. No.: 19/140,732

(22) PCT Filed: Nov. 20, 2023
(86) PCT No.: PCT/SE2023/051169

§ 371 Date: Jun. 18, 2025

(30) Foreign Application Priority Data
Dec. 19, 2022 (SE) 2251485-5

(51) Int. Cl. G05D 1/246; A01D 34/00; A01D 101/00; G05D 1/648; G05D 107/20

(52) U.S. Cl. CPC G05D 1/246; A01D 34/008; G05D 1/648; A01D 2101/00; G05D 2107/23

(57) ABSTRACT

The present disclosure relates to a method for accomplishing an augmented reality user interface in a robotic lawnmower system. The system includes a robotic lawn-mower (1), configured to process a work area (3), and a separate, mobile device (11) comprising a display (13). Position data relating to the robotic lawnmower's currently sensed position in the work area coordinate system is received by the mobile device, and a mapping is identified between positions in the work area and pixels on said display by identifying a position in a predetermined relation to the robotic lawnmower (1) together with the current position. The said user interface is provided on the display (13) using said mapping.

### TECHNICAL FIELD

The present disclosure relates to a mapping method for a robotic lawnmower system comprising a robotic lawnmower, configured to process a work area, and a separate, mobile device comprising a display with pixels providing a user interface, wherein the robotic lawnmower has access to a work area coordinate system and is configured to sense its position in that coordinate system. The user interface produces images, using said display, from the work area captured by the mobile device together with additional features in the user interface.

### BACKGROUND

A robotic lawnmower system of the initially mentioned type is shown in US-2021/0018927-A1. In that system, image data corresponding to a set of images of a lawnmower worksite are captured by a mobile computing device, such as a smart phone. A set of virtual markers associated with the set of images are identified, each having a corresponding position in one of the images. For each virtual marker, a set of coordinates in a coordinate system based on the corresponding position of the virtual marker are determined. From the set of coordinates, boundary data is generated and communicated to a robotic mower, which is operated within a boundary defined by the boundary data.

Such systems in general may provide boundary data that can be used by a robotic lawnmower or indeed another type of autonomous work tool. However, relatively low precision compared to a legacy-type boundary provided by a boundary wire must be accepted, even if the robotic work tool per se can navigate with considerably higher precision.

Further, the usefulness of such a user interface is very limited. In most cases, a work area for a robotic lawnmower is defined as an outer boundary once and for all, and then the user interface has no further purpose.

### SUMMARY

One object of the present disclosure is therefore to provide a robotic lawnmower system with improved precision and/or a more useful user interface.

This object is achieved by means of a robotic lawnmower system as defined in claim 1. More specifically, in a method in a robotic lawnmower system of the initially mentioned kind, the separate, mobile device receives current position data relating to the robotic lawnmower's sensed position in the work area coordinate system. The mobile device identifies a mapping between positions in the work area and pixels on said display by identifying a position in a predetermined relation to the robotic lawnmower together with said current position and provides the user interface on the display using the mapping.

This provides a user interface where the work area coordinate system of the separate mobile device and of the robotic lawnmower are well aligned. The user interface can provide data to and receive data from the robotic lawnmower with high precision that allows for more exact control of the robotic work tool.

The above-mentioned position in a predetermined relation to the robotic lawnmower may be identified with the separate mobile device attached to the robotic lawnmower. This provides a very exact relation between the robotic lawnmower and the separate mobile device during calibration. The separate, mobile device may be attached to the robotic lawnmower by means of a socket thereon. While the mobile device is attached to the robotic lawnmower the latter may change its position and/or heading. This provides more data for use in calibration.

Alternatively, the separate mobile device may film the robotic lawnmower. Then, the position with the predetermined position in relation to the robotic lawnmower may be the position of the lawnmower itself. By identifying the robotic lawnmower in an image and knowing its position as sensed by the lawnmower itself, the user interface can be calibrated to the work area coordinate system very precisely.

The robotic lawnmower may move while being filmed, and the separate mobile device receives current position data relating to the robotic lawnmower's sensed position in the work area coordinate system at two or more positions. This provides more data useful for calibration of the mapping.

The robotic lawnmower may be identified in the images captured by the separate mobile device, or a symbol located on the robotic lawnmower may be identified. This can be done with basic segmentation techniques and provides the robotic lawnmower's position in the image.

The robotic lawnmower may also report its heading to the separate mobile device.

The present disclosure also considers several use cases which can be carried out with a user interface aligned with the robotic lawnmower with high precision, for instance aligned as outlined above. Note however that the requirement of a high grade of alignment can be achieved in other ways. For instance, both the robotic lawnmower and the separate mobile device can be provided with an RTK function which provides cm level positioning in both devices in a common, global coordinate system which is of course aligned with itself.

To start with, the present disclosure considers a method in a robotic lawnmower system comprising a robotic lawnmower, configured to process a work area, and a separate, mobile device comprising a display with pixels providing a user interface, wherein the robotic lawnmower has access to a work area coordinate system and is configured to sense its position in that coordinate system, and the user interface produces images, using said display, from the work area captured by the mobile device together with additional features in the user interface, wherein pixels on the display are mapped to positions in the work area. The method includes inputting at least one border in the display of the separate, mobile device while the display provides an image of the work area where the border is to be located, transferring data corresponding to the at least one border to the robotic lawnmower, and operating the robotic lawnmower using the transferred data. This provides an efficient function for programming a robotic lawnmower with a work area border.

The border may be edited on the display prior to transferring the data.

In another considered method the robotic lawnmower may detect a break in a boundary cable, transfer data corresponding to the break to the separate mobile device, and the separate mobile device may indicate the location of the break on the display as an additional feature. This provides a convenient way of indicating the location of a break to a user. Such breaks may otherwise be difficult to find.

Data corresponding to the boundary cable may also be transferred to the separate mobile device and rendered on the display as an additional feature.

If the break is outside the part of the work area in the displayed image, an indication illustrating the direction to the break may be shown.

In a further considered method, the robotic lawnmower transfers data corresponding to its position to the separate mobile device, and the separate mobile device indicates the location of the robotic lawnmower on the display as an additional feature. This allows the robotic lawnmower to be found when used on a large area.

In a still further considered method, the robotic lawnmower transfers data corresponding to its intended processing area and/or intended path to the mobile device, and the separate mobile device indicates the intended processing area and/or intended path on the display as an additional feature on the display. In this way, a user can quickly obtain information about what the robotic lawnmower is about to do.

In yet another considered method, a pattern is input to the display of the separate, mobile device while the display provides an image of the work area where the border is to be located. Data corresponding to the at least one pattern is transferred to the robotic lawnmower, and the robotic lawnmower is operated using the transferred data to replicate the pattern on the work area.

The present disclosure also considers data processing equipment comprising at least one processor and a memory, configured to carry out any method as defined above. A corresponding computer program product is considered too, as is a computer-readable storage medium having the program stored thereon.

The present disclosure also considers robotic lawnmower system, configured to carry out the steps of the above methods.

### BRIEF DESCRIPTION OF THE DRAWINGS

FIG. 1 illustrates a use scenario with a robotic lawnmower, operating in a work area, and an AR user interface.

FIG. 2 illustrates geometric factors of a separate mobile device.

FIGS. 3A and 3B illustrate a first calibration scenario.

FIG. 4 illustrates an alternative calibration scenario.

FIG. 5 shows a robotic lawnmower.

FIG. 6 illustrates the relationship between work area data in different systems.

FIG. 7 illustrates editing a work area in a user interface.

FIGS. 8A and 8B illustrate indicating a break in a boundary cable.

FIG. 9 illustrates indicating the location of two separate robotic lawnmowers.

FIG. 10 illustrates paths and sub-areas indicated in a unser interface.

FIG. 11 illustrates adding a pattern in a user interface.

### DETAILED DESCRIPTION

The present disclosure relates to robotic lawnmower systems. Such systems comprise a robotic lawnmower, or similar device, which is configured to process a work area. Further, a charging station, intermittently charging the lawnmower may be provided, although in the context of the present disclosure, the lawnmower in principle could be powered by an internal combustion engine and have a liquid fuel tank.

The lawnmower is configured to autonomously process the work area in a structured or more or less random fashion depending on desired settings. In the context of this disclosure, the lawnmower is configured to be aware of its position in the work area as well as the extension in the work area. This may be accomplished using a satellite navigation system, which may be enhanced using real-time kinematics, RTK, to obtain a precision of down to a few centimeters with regard to the lawnmower's position. However, although the robotic lawnmower navigating using RTK is preferred, a coarser positioning may be considered as well, especially if the work area is large or if the satellite navigation positioning is combined with for example a boundary cable that can be detected by the lawnmower.

Methods exist to interact with the lawnmower in different ways in order to establish rules for the lawnmower. For instance, it has been suggested to lead the lawnmower around the outer boundary of the work area once, the lawnmower being remotely controlled, and letting the lawnmower record the positions of the outer boundary using its navigation system. This allows the robotic lawnmower to recognize its work area. This technique, sometimes referred to as “walk-the-dog”, is relatively time-consuming and not very flexible. If the user decides to change the boundary to some extent, the process will likely need to be repeated, even if the change is small.

One alternative could be to upload the generated position data to a remote device such as a laptop, to edit the border, or other features, in an interface of the laptop and to subsequently download the edited position data to the lawnmower, such that the lawnmower can be operated in the updated work area, for instance. While this is possible, it is likely that the updating will be done in another location and without the immediate access to the work area itself. This makes the editing less intuitive.

### AR Interface

Therefore, in this context, the use of so-called augmented reality, AR, functions are considered a promising alternative. Then, a user interface is provided on a separate, mobile device which is capable of producing on a display images of the actual work area, using an in-built camera providing a field of view. The mobile device is further capable of displaying the produced images on a screen or display. The mobile device may typically be a smartphone or a tablet, although other alternatives would be conceivable.

The separate mobile device may be in direct contact with the robotic lawnmower, via a wireless interface, such as Bluetooth. Alternatively, the communication may take place via a third, remote node, or each of the robotic lawnmower and the separate mobile device may communicate with the third, remote node where coordination of data takes place.

The present disclosure considers an AR user interface that can operate either for user interface input, user interface output, or both.

Generally, by providing an AR user interface, a user may input matter by drawing or marking features in the display, which will be assigned positions in the display that correspond to positions e.g. in the garden. The features input may appear super-imposed or overlayed on the images of the garden and will move correspondingly when the mobile device camera view is changed. Note that overlayed matter in the image may also originate from other sources than user inputs, for instance downloaded GIS, geographic information system, data may be displayed overlayed on the garden image as seen on the display by the user.

The user may thus, in an image presenting a part of a garden, input a border segment, for instance by drawing with his finger on a touch screen showing the image. This border segment may be shown on the screen such that the user can verify its location in the image in real time. At the same time, position data related to the coordinate system in which the robotic lawnmower operates can be generated, and can be transmitted to the robotic lawnmower, directly or via one or more intermediate nodes. In general, the AR user interface displays additional features related to the work area on top of the image produced on the display in the user interface.

It is thus also possible to output data relating to the robotic lawnmower on the screen of the separate mobile device. For instance, if the user wants to see the outer boundary which the robotic lawnmower uses to define the work area, is possible to display a part of that boundary in an image shown in the screen, given that the part of the work area presently displayed incorporates a segment of the boundary. If not, it would be possible, instead, to display an indicator such as an arrow showing the direction and/or distance to the closest segment of the boundary, for instance.

Further use cases of a user interface of this type will be discussed.

### Calibration

In order for such a user interface to work properly, a position on the screen of the separate mobile device, defined by screen coordinates/pixels, must correspond to a position in the work area as defined in the robotic lawnmower with high precision.

Any significant deviation between the two coordinate systems, or worse a progressing drift between the two, will render the user interface more or less useless. The present disclosure therefore includes improved calibration schemes to link the coordinate system on the screen with the one employed by the robotic lawnmower.

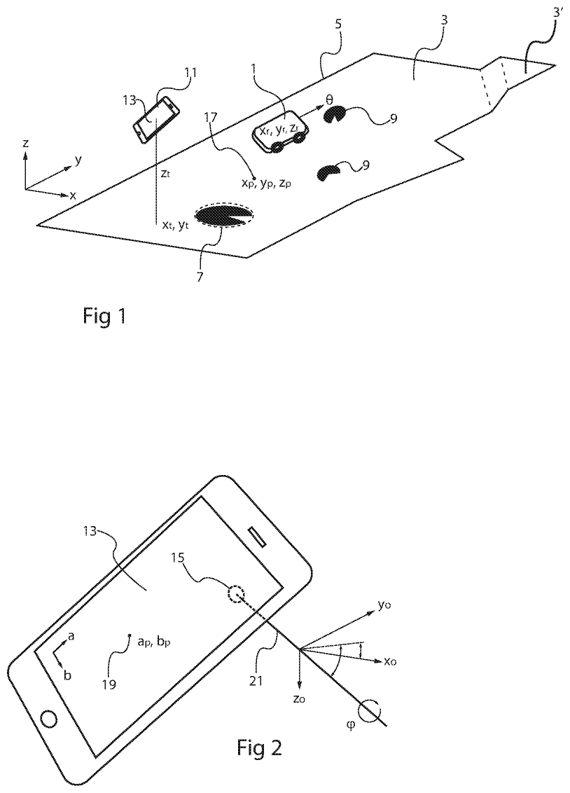

In FIG. 1 a use scenario with a robotic lawnmower 1 operating in a work area 3 is illustrated, typically defined by an outer boundary 5 and optionally one or more inner boundaries 7, as illustrated. The robotic lawnmower 1 is located in a position xᵣ, yᵣ, typically defined in a Cartesian coordinate system, although a polar coordinate system would in principle be an alternative. This is in fact simplified, as the work area 3, need not be flat, having a raised portion 3′, for instance. Therefore, a third coordinate zᵣ may be included, as shown. The robotic lawnmower 1 may further have a defined heading θ. Generally, the robotic lawnmower 1 may be configured to remain within the outer boundary 5 while avoiding areas therein defined by the inner boundaries 7, typically corresponding to a flower bed, a pond or the like. The robotic lawnmower may further be devised to autonomously detect and avoid other objects 9 in the work area 3, which are not directly defined by a specific boundary.

In the illustrated case, a separate mobile device 11 in the form of a smartphone is provided to procure a user interface. As mentioned, another type of a device such as a tablet may be considered. In any case, the separate mobile device 11 comprises a display 13 where an image of a part of the work area 3 instantaneously imaged, can be displayed. Typically, the separate mobile device 1 comprises a camera 15 (cf. FIG. 2) that can be placed on the side of the separate mobile device 11 that is opposite to the display 13 although this is not necessary.

Using the separate mobile device 11, an image of a part of the work area 3 is produced on the aforementioned display 13 including an example position 17 expressed with the coordinates xₚ, yₚ, zₚ.

This position 17 will, with reference to FIG. 2, be represented by a corresponding position aₚ, bₚ 19 on the display 13, typically corresponding to one or more pixels in the display.

The relation between the work area position 17 and the corresponding display position 19 depends on several parameters as will be discussed.

To start with, returning to FIG. 1, the separate mobile device's 11 position in the space of the work area 3 must be considered and can, as illustrated, be designated as xₜ, yₜ, zₜ. Additionally, the separate, mobile device's 11 orientation in the work area space must be considered. Although different implementations are possible, this can suitably be considered based on the orientation of the optical axis 21 of the camera 15 used to acquire the image data and indicated in FIG. 2. This can be expressed in a normalized manner using parameters x₀, y₀, z₀, which may for instance each vary between −1 and +1 to describe any given direction of the optical axis 21 in the work area space.

However, this may not be enough, since the separate, mobile device 1 may also roll about the optical axis 21 of its camera 15. Therefore, a parameter φ, corresponding to this roll can be considered as well.

With knowledge of all these parameters any position aₚ, bₚ on the display can thus be interpreted as a position xₚ, yₚ, zₚ in the work area 3 and vice versa given that the shape of the work area is known as well.

The parameters can be determined in different ways. The separate, mobile device's 1 position in the work area space, xₜ, yₜ, zₜ may for instance be determined using real time kinematics, RTK, and an RTK function may either be built into the separate, mobile device 1 itself or may be provided by a unit in close vicinity to and in communication with the separate, mobile device.

With knowledge of those parameters and further using accelerometers in the separate, mobile device 1, the remaining parameters, x₀, y₀, z₀, φ may be determined. Using this set of parameters, any point 17 on the work area can be mapped to a corresponding point aₚ, bₚ 19 on the display 13 or vice versa, of course given that the camera 15 captures the point 17 in question. Unless the work area 3 is flat, the mapping could be configured to be adjusted based on the point's 17 deviation in the z direction.

Some options exist to simplify the mapping. To start with, in many cases the work area can be considered flat, thereby eliminating zₚ (however not zₜ). Further, the user can be required to orient the separate, mobile device 11 in a predetermined manner, for instance in portrait mode or, as shown in FIG. 4 in landscape mode. Thereby, the roll o is eliminated by being known.

It should be understood that any sensor data from the separate, mobile device 11 including the data used to detect its position in the work area space and its orientation in said space will include a small error component. The same goes for the robotic lawnmower 1 which will not detect its position with absolute precision. Those sets of error components will compound when the separate, mobile device 11 is used to control the robotic lawnmower 1, and corresponding error components are produced when the sensors of the robotic lawnmower 1 outputs data for displaying in the interface. As those sets of error components are mutually more or less independent, both will contribute to lacking the precision when the robotic lawnmower is handled by means of the separate, mobile device's display. In some cases, this may be acceptable while in other cases, where high precision is needed, performance will be insufficient.

In the present disclosure, it is proposed to increase precision by calibrating the separate, mobile device 13 using the current position as determined by the robotic lawnmower. This means that the AR interface produced by the separate, mobile device 11 is directly linked to the position actually sensed by robotic lawnmower 1. Thereby, one source of error components is removed or reduced.

This can be carried out in different ways. To start with, it is possible to temporarily locate the separate, mobile device 11 on the robotic lawnmower 1 and carry out a calibration sequence. As an alternative, it is possible to keep the separate, mobile device 13 apart from the robotic lawnmower 1 and instead record the position of the robotic lawnmower 1 itself. Both these options will be described in detail.

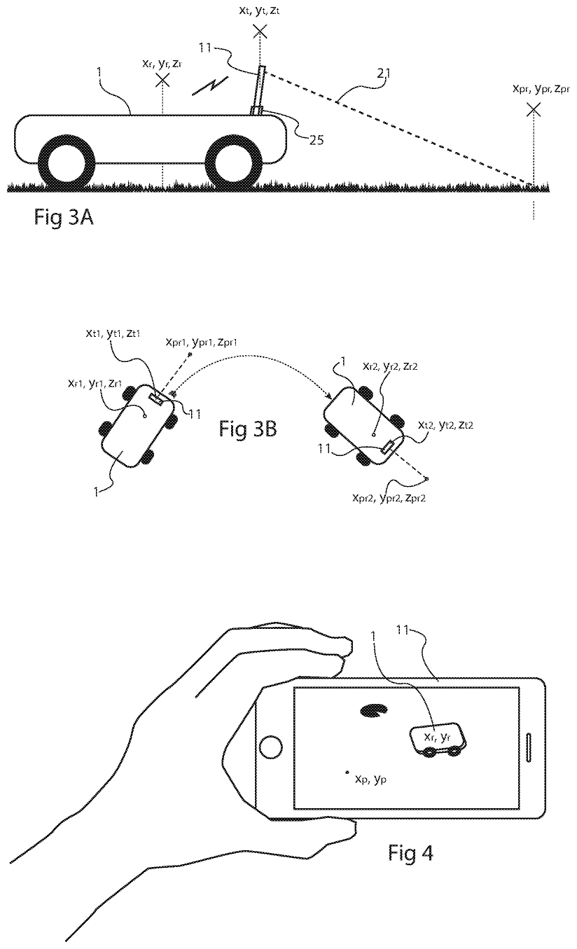

A first possibility is illustrated in FIG. 3A and FIG. 3B. To start with, it is possible to temporarily locate the separate, mobile device 13 on the robotic lawnmower 1 and carry out a calibration sequence. Thus, although being a unit separate from the robotic lawnmower 1, it may be attached thereto for the purpose of obtaining a calibration.

As illustrated in FIG. 3A, the separate, mobile device 11 may be attached to the robotic lawnmower 1, for instance being inserted in a socket 25 on top of the robotic lawnmower 1. In this way, the separate, mobile device 11, and specifically the optical axis 21 of its camera 15 will have a predetermined relation to the wheel axes of the robotic lawnmower 1, and consequently to the surface of the work area at the location of the robotic lawnmower 1. The position xₜ, yₜ, zₜ of the separate, mobile device 11 will therefore have a predetermined relation to the position xᵣ, yᵣ, zᵣ the robotic lawnmower 1. Moreover, as the separate, mobile device 11 can be fixed in a specific way in relation to the robotic lawnmower, the orientation and roll of the separate, mobile device 11 can be readily resolved. A position xₚᵣ, yₚᵣ, zₚᵣ viewed by the separate, mobile device 11 can thereby be determined by the separate mobile device 11 in the coordinate system of the robotic lawnmower 1 using position data from the robotic lawnmower 1. This position has a well-defined relation to the position of the robotic lawnmower.

This may need to be compensated for based on varying elevation of the work area 3. The robotic lawnmower 1 may communicate, e.g. using a short-range communication system, its position xᵣ, yᵣ, zᵣ to the separate mobile device 11, such that the latter can take into account any errors that arise in the former's detection of its position.

To further enhance the mapping between the sensed coordinate systems, the robotic lawnmower 1 can carry out a movement sequence while the mapping takes place, for instance as illustrated in FIG. 3B. Then, the robotic lawnmower moves from a first position Xᵣ₁, Yᵣ₁, Zᵣ₁ to a second position, Xᵣ₂, Yᵣ₂, Zᵣ₂, while at the same time the separate mobile device, for the time being not being separate at all, moves from position Xₜ₁, Yₜ₁, Zₜ₁ to position Xₜ₂, Yₜ₂, Zₜ₂ and correspondingly maps positions Xₚᵣ₁, Yₚᵣ₁, Zₚᵣ₁ and Xₚᵣ₂, Yₚᵣ₂, Zₚᵣ₂ with predetermined relations to the robotic lawnmower to its display. All positions detected and mapped during this movement may be taken into account as well, and the change in orientation too if as illustrated the robotic lawnmower 1 turns. During the movement or at the beginning and end thereof, the robotic lawnmower 1 may communicate its position and heading to the separate, mobile device 11, and in this way the latter may calibrate its perception of the work area to the robotic lawnmower's corresponding perception.

FIG. 4 illustrates another example of a calibrating procedure. In this case, the separate mobile device 11 is not attached to the robotic lawnmower 1, but rather takes a picture or a series of pictures of the robotic lawnmower 1 itself. At the same time, the robotic lawnmower 1 may report its position xᵣ, yᵣ and heading to the separate, mobile device 11. This procedure as well allows the separate, mobile device 11 to align its perception of the work area 3 with that of the robotic lawnmower 1. The position with the predetermined position xₚᵣ, yₚᵣ, zₚᵣ in relation to the robotic lawnmower 1 may be the position xᵣ, yᵣ, zᵣ of the lawnmower 1 itself, or another position with a well defined relationship to the geometry of the robotic lawnmower.

In this case too, the robotic lawnmower 1 may move during the calibration. Thereby, a specific position xₚ, yₚ on the work area may be well aligned in the user interface and in the detection of the robotic lawnmower 1.

Thus, when identifying a mapping between positions xₚ, yₚ, zₚ in the work area and pixels aₚ, bₚ on the display, a position xₚᵣ, yₚᵣ, zₚᵣ in a predetermined relation to the robotic lawnmower 1 is identified and combined with the current position as identified by the robotic lawnmower. The position xₚᵣ, yₚᵣ, zₚᵣ in a predetermined relation to the robotic lawnmower 1 may be the actual position xᵣ, yᵣ, zᵣ of the robotic lawnmower 1 or another position with a predetermined relation thereto, e.g. xᵣ, yᵣ, zᵣ plus one meter in the heading of the robotic work tool.

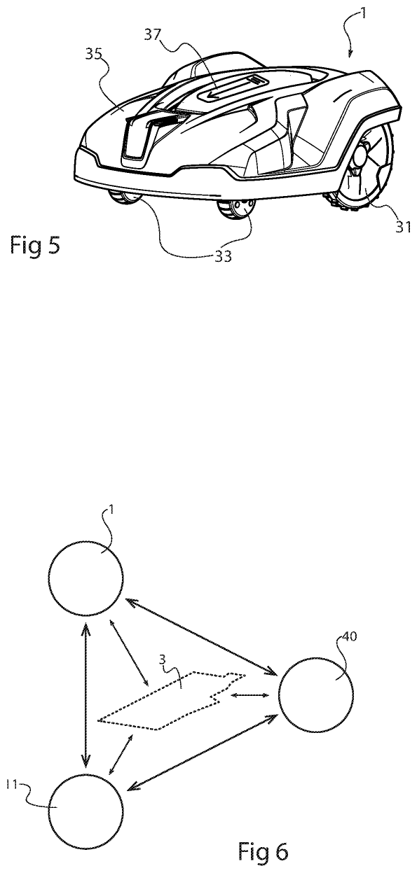

FIG. 5 illustrates an example of a robotic lawnmower 1 in greater detail. As illustrated, the back 31 and front 33 wheels may be partly visible and its outer shell 35 may have a characteristic shape. Additionally, specific visual markers 37 may be disposed on the outer shell 35, for instance as shown an arrow indicating the heading of the robotic lawnmower 1.

All those features of the robotic lawnmower 1 may, in the context of the calibration procedure described in connection with FIG. 4, be used to verify the alignment between the coordinate systems as the separate, mobile device 11 may be able to detect the presence of the robotic lawnmower, to estimate its distance to and elevation with respect to the robotic lawnmower 1, and to detect the robotic lawnmower's 1 heading. All this can be achieved by the separate mobile device 13 having or acquiring data concerning the visual appearance of the robotic lawnmower 1.

FIG. 6 illustrates the relationship between work area data in different parts of a system. In many cases, the work area 3 may be defined by a user in a remote device 40, for instance a laptop and the work area may be based on GIS (Geographic Information System) data, for instance as downloaded from a commercial database. The remote device 40 may also be a server or may even be arranged in a charging station of the lawnmower system.

The work area 3 may then be defined by a set of coordinates in a geodetic system format such as WGS84, providing positions such as 57°51′10.4″N; 16°33′23.4″E. The robotic lawnmower 1 and the separate, mobile device 11 may thereafter download the position data and navigate after their perception of the work area 3. The work area 3 may be refined using the user interface 11 or by autonomous operation of the robotic lawnmower 1.

It should be noted that the remote device 40 is not necessary in the context of the present disclosure, where the work area positions could be generated in one of the robotic lawnmower 1 and the separate, mobile device 11 and subsequently transferred to the other. For instance, the aforementioned “walk the dog” procedure could be used to generate an initial sketch of a work area 3, which is then refined in the interaction using the robotic lawnmower's autonomous operation, the user interface in the separate mobile device 13, or a combination thereof. Optionally, the refined work area 3 could again be uploaded to the remote device 40.

With the calibration procedure described above, the user interface can compensate for errors in the robotic lawnmower's perception of its work area position as it is calibrated based on the position actually detected by the robotic lawnmower 1.

### Interface Applications

With an AR user interface as initially described, where positions sensed by a robotic lawnmower 1 maps to images captured and displayed by a separate, mobile device 11, instructions and information may be transferred in both directions between the robotic lawnmower 1 and the separate, mobile device 11, in order to provide different functionalities as will be described.

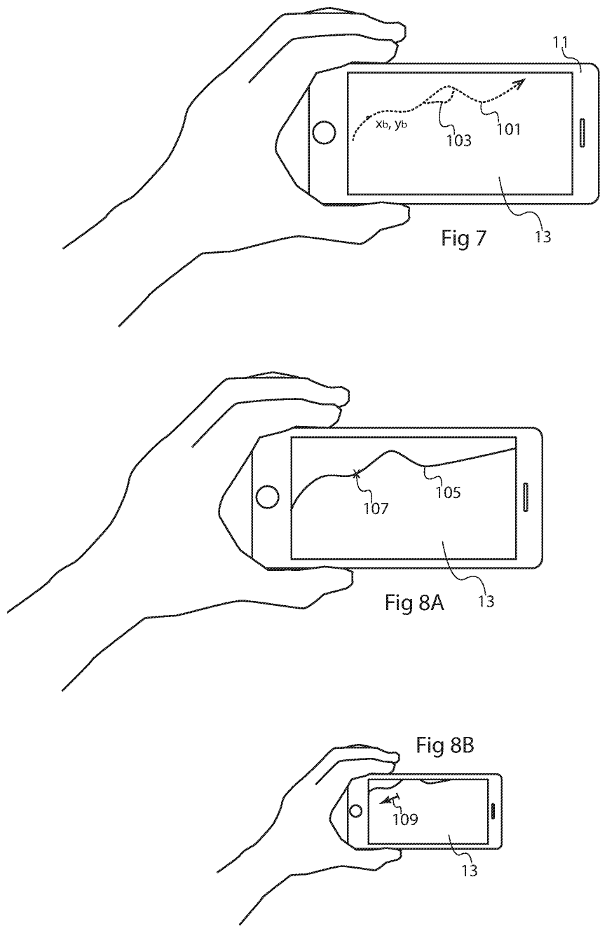

To start with, the user may define work area 3 boundaries 5 to be used by the robotic lawnmower 1. As illustrated in FIG. 7, this may be done using a touch sensitive display 13 on the separate mobile device 11. The user then defines a set of positions xb, yb to form a part of the boundary 5 by swiping a finger over the display 13 along a trace 101. It is possible to edit the trace 101 at parts thereof, thereby providing a partial edited trace 103. In this way, the user may define inner 7 and outer 5 boundaries (cf. FIG. 1) along the borders of the intended work area 3. It is possible to establish a rough, initial work area at a larger distance from the intended outer boundary 5 to form a first draft. This may then be edited capturing images at a closer distance to fine-tune boundaries at certain locations. Once the boundaries have been established, they can be transferred to the robotic lawnmower 1 which operates accordingly. It is possible to define other rules for the robotic lawnmower's 1 operation in the separate mobile device 11. For instance, the work area 3 may be divided into a plurality of sub-parts that should be processed in a specific order or at specific times of the day, for instance. Some sub-areas may be processed only under special conditions, for instance when the lawn is not too wet. Some parts of a garden may only be reached through narrow passages, and it is possible to indicate in the user interface how those parts are reached by defining a passage.

This programming can be done as well by creating traces on the display of the mobile device, and the sub-areas and passages may be added to the data sent to the robotic lawnmower 1. All entries can be transferred to the robotic lawnmower, providing rules under which it may operate.

It is further possible to edit work area boundaries that are already established elsewhere. For instance, an initial work area template could be downloaded to the robotic work tool from commercial GIS database. This could be done via a remote device 40 (cf. FIG. 6), and it is possible to carry out initial editing in the remote device 40, if desired. Once the work area data has been sent to the robotic lawnmower 1, it may operate accordingly. The robotic lawnmower 1 may now send its work area data to the separate, mobile device 11 where the work area boundaries 5, 7 are fine-tuned as described above. Then, the edited data is sent back to the robotic lawnmower 1, which operates accordingly. It is also possible to send the initial data directly to the separate, mobile device 11 for editing and forwarding the edited data to the robotic lawnmower 1.

In some cases, the robotic lawnmower system may be provided with a boundary cable as an additional navigation feature. This may be the case where safety regulations require that a physical boundary cable is provided to make sure that the robotic lawnmower 1 is capable of at least staying within the work area 3 even in a case where a satellite navigation system temporarily fails, for instance. One issue with boundary cables is that they may break, and that a cut is not readily visible, since the cable in most cases is buried. By employing a user interface as disclosed herein, it is possible to indicate the break location such that the cable can be repaired. It is possible, using electric sensors in the robotic lawnmower to detect a break in a buried cable, typically detecting an abrupt phase change in a signal or a signal disappearing at the break. The break may also be detected by the robotic lawnmower charging station (not shown), especially if the charging station feeds an electric signal to the boundary cable, which is common. The charging station then sends a message including how far out along the cable the break is located. Then, the robotic lawnmower 1 or the mobile device 11 may resolve the position of the break in the work area with knowledge of where the cable is buried.

That position 107 on an indicated cable 105 can be shown on the display 13, as illustrated in FIG. 8A. Note that neither are visible in the raw image taken by the separate mobile device's camera, this is added to the image by the separate mobile device 11 as additional features.

If the mobile device 11 films an area not including the cable break, an indicator 109 such as an arrow may instead show the closest way to the break on the display 13.

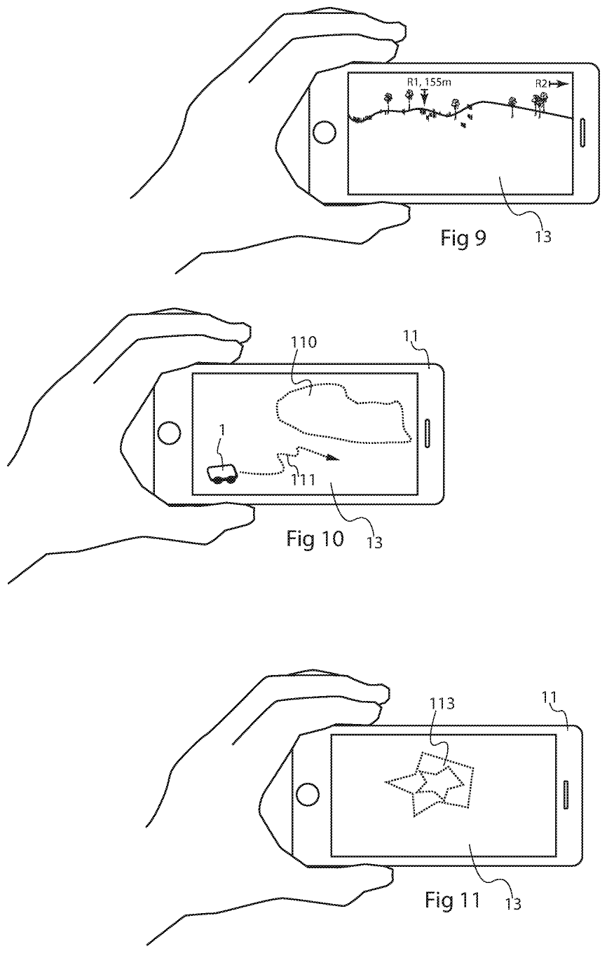

Further, the user interface may assist the user in finding the robotic lawnmower 1. This may be useful in the case the robotic lawnmower has become stuck or is not functioning properly. While in most residential property gardens, which are rather small, the robotic lawnmower can easily be found, this can be a problem in larger installations. For instance, even a small golf course can cover several hectares often with hills and shrubberies which can obscure the robotic lawnmower. Also, in such installations, several robotic lawnmowers are often used, and it can be difficult to know which robotic lawnmower is spotted. By means of the present user interface, the location of a specific robotic lawnmower can be efficiently indicated. As shown in FIG. 9, the user may direct the mobile device towards the horizon, and the user interface shows by means of one arrow the direction and numerically indicates the distance to the robotic lawnmower with identity R1. The user interface also indicates in which direction the view of the mobile device is to be turned to be able to indicate a second robotic lawnmower, R2.

While the robotic lawnmower for the most part may be intended to operate autonomously, while considering the rules defined in connection with the work area, the user may in some cases temporarily want to take control of the mowing. This can be done by means of the disclosed AR user interface as illustrated in FIG. 10. Then the user may, using a finger, indicate on the input display 13 of the mobile device an area 110 that the robotic lawnmower 1 is to process. This corresponds to positions inside the work area that are supposed to form a temporary processing area, and the corresponding position and instruction data is transferred to the robotic lawnmower 1 which is configured to receive the data and act accordingly. In the same way, a trace 111 that the user wants the robotic lawnmower 1 to follow may be indicated. The robotic lawnmower 1 then processes along a corresponding path in the work area.

Similarly, the robotic lawnmower 1 may indicate to the user interface the path it is about to follow, and the area it is currently processing. Corresponding data may be transferred from the robotic lawnmower 1 to the mobile device 11 which can render corresponding data on the image of the garden in the display, in the same way as is shown in FIG. 10.

As illustrated in FIG. 11, it is even possible to generate or download a pattern 113 to the mobile device 11 and to locate that pattern at a desired location on the display 13 when viewing a portion of the work area 3. The mobile device 11 may then transfer data defining the corresponding positions in the work area and an instruction to the robotic lawnmower, which can receive the data and carry out processing accordingly. In this way the desired pattern 113 can be replicated on the lawn as cut portions contrasting against uncut portions. Thereby, for instance a logotype or a message can be conveniently displayed on the lawn.

The invention is not restricted to the described embodiments and may be varied and altered in different ways within the scope of the appended claims.

1. A mapping method for a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display, from the work area captured by the mobile device together with additional features in the user interface, characterized by the separate, mobile device (11)
receiving current position data (xᵣ, yᵣ, zᵣ) relating to the robotic lawnmower's sensed position in the work area coordinate system,
identifying a mapping between positions (xₚ, yₚ, zₚ) in said work area and pixels (aₚ, bₚ) on said display by identifying a position (xₚᵣ, yₚᵣ, zₚᵣ) in a predetermined relation to the robotic lawnmower (1) together with said current position, and
providing said user interface on the display (13) using said mapping.

2. Method according to claim 1, wherein the position (xₚᵣ, yₚᵣ, zₚᵣ) in a predetermined relation to the robotic lawnmower (1) is identified with the separate, mobile device (11) attached to the robotic lawnmower.

3. Method according to claim 2, wherein the separate, mobile device (11) is attached to the robotic lawnmower (1) by means of a socket (25) thereon.

4. Method according to claim 2 or 3, wherein the robotic lawnmower (1) changes its position and/or heading while the mobile device (11) is attached thereon.

5. Method according to claim 1, wherein the with the separate mobile device (11) films the robotic lawnmower, such that the position with the predetermined position (xₚᵣ, yₚᵣ, zₚᵣ) in relation to the robotic lawnmower (1) is the position of the lawnmower.

6. Method according to claim 5, wherein the robotic lawnmower moves while being filmed, and the mobile device receives current position data (xᵣ, yᵣ, xᵣ) relating to the robotic lawnmower's (1) sensed position in the work area coordinate system at two or more positions.

7. Method according to claim 5 or 6, wherein the robotic lawnmower (1) is identified in the images captured by the separate mobile device (11).

8. Method according to claim 5 or 6, wherein a symbol (37) located on the robotic lawnmower (1) is identified in the images captured by the separate mobile device (11).

9. Method according to any of the preceding claims, wherein the robotic lawnmower (1) reports its heading (0) to the separate mobile device (11).

10. A method in a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display, from the work area captured by the mobile device together with additional features in the user interface, wherein pixels on the display (13) are mapped to positions in the work area, characterized by
inputting (101) at least one border (5, 7) in the display (13) of the separate, mobile device (11) while the display provides an image of the work area where the border is to be located,
transferring data corresponding to the at least one border (5, 7) to the robotic lawnmower (1), and
operating the robotic lawnmower (1) using the transferred data.

11. Method according to claim 10, wherein the border is edited (103) on the display (13) prior to transferring the data.

12. A method in a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display (13), from the work area captured by the separate, mobile device (11) together with additional features in the user interface, wherein pixels on the display (13) are mapped to positions in the work area, characterized by the robotic lawnmower (1)
detecting a break (107) in a boundary cable (105),
transferring data corresponding to the break (107) to the separate mobile device (11), and
the separate mobile device (11) indicating the location of the break (107) on the display (13) as an additional feature.

13. Method according to claim 12, wherein data corresponding to the boundary cable (105) is transferred to the separate mobile device (11) and is rendered on the display (13) as an additional feature.

14. Method according to claim 12 or 13, wherein, if the break (105) is outside the part of the work area in the display image, and indication (109) illustrating the direction to the break is shown.

15. A method in a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display (13), from the work area captured by the separate, mobile device (11) together with additional features in the user interface, wherein pixels on the display (13) are mapped to positions in the work area, characterized by the robotic lawnmower (1)
transferring data corresponding to its position (xᵣ, yᵣ, zᵣ) to the separate mobile device (11), and
the separate mobile device (11) indicating the location of the robotic lawnmower (1) on the display (13) as an additional feature.

16. A method in a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display (13), from the work area captured by the separate, mobile device (11) together with additional features in the user interface, wherein pixels on the display (13) are mapped to positions in the work area, characterized by the robotic lawnmower (1)
transferring data corresponding to its intended processing area and/or intended path to the mobile device (11), and
the separate mobile device (11) indicating the intended processing area (110) and/or intended path (111) on the display (13) as an additional feature.

17. A method in a robotic lawnmower system comprising a robotic lawnmower (1), configured to process a work area (3), and a separate, mobile device (11) comprising a display (13) with pixels providing a user interface, wherein the robotic lawnmower (1) has access to a work area coordinate system and is configured to sense its position in that coordinate system, and the user interface produces images, using said display, from the work area captured by the mobile device together with additional features in the user interface, wherein pixels on the display (13) are mapped to positions in the work area, characterized by
inputting (101) at least one pattern (113) in the display (13) of the separate, mobile device (11) while the display provides an image of the work area where the border is to be located,
transferring data corresponding to the at least one pattern (113) to the robotic lawnmower (1), and
operating the robotic lawnmower (1) using the transferred data to replicate by cutting the pattern (113) on the work area.

18. Data processing equipment comprising at least one processor and memory, configured to carry out the method of any of the claims 1-17

19. A computer program product comprising instructions which, when the program is executed on a processor, carries out the method according to any of the claims 1-17.

20. A computer-readable storage medium having stored thereon the computer program product of claim 19.

21. A robotic lawnmower system, comprising a robotic lawnmower (1), configured to process a work area (3), and a separate, mobile device (11) comprising a display (13) with pixels providing a user interface, wherein the robotic lawnmower (1) comprises a work area coordinate system and is configured to sense its position in that coordinate system, and the user interface produces images, using said display, from the work area captured by the mobile device together with additional features in the user interface, characterized by the system being configured to map pixels of the display (13) to positions in the coordinate system of the robotic lawnmower (1) the separate, mobile device (11) being configured to
receive current position data (xᵣ, yᵣ, zᵣ) relating to the robotic lawnmower's sensed position in the work area coordinate system,
identify a mapping between positions (xₚ, yₚ, zₚ) in said work area and pixels (aₚ, bₚ) on said display by identifying a position (xₚᵣ, yₚᵣ, zₚᵣ) in a predetermined relation to the robotic lawnmower (1) together with said current position, and
provide said user interface on the display (13) using said mapping.
